(19) United States
(12) Patent Application Publication
(10) Pub. No.: US 2009/0168663 A1
(43) Pub. Date: Jul. 2, 2009

(54) Reducing Configuration of OAM Signalling Data

(75) Inventors: Robert Friskney, Harlow (GB); Chris Ramsden, Hertford (GB)

Correspondence Address: BARNES & THORNBURG LLP, P.O. BOX 2786, CHICAGO, IL, 60690-2786, US

(73) Assignee: NORTEL NETOWRKS LIMITED, St. Laurent (CA)

(21) Appl. No.: 11/964,534

(22) Filed: Dec. 26, 2007

(51) Int. Cl. H04L 12/28; H04L 12/24

(52) U.S. Cl. 370/254; 370/241.1; 370/401

(57) ABSTRACT

OAM data is automatically configured by each node of an Ethernet network. The OAM data is required to support an OAM signalling session associated with a connection for carrying data traffic between nodes. The OAM data can be derived from data already associated with all endpoints of the connection. The node can derive the OAM data autonomously. A node which is an endpoint of an OAM signalling session automatically derives an identifier for the first endpoint. The first identifier can be autonomously derived by the node and other signalling content, such as source MAC address, is used to differentiate OAM signalling messages. Alternatively, a node can automatically configure the first identifier on the basis of information stored locally at the node and signalling with a second endpoint. The OAM data can be IEEE 802.1ag or ITU Y.1731 data.

### FIELD OF THE INVENTION

This invention relates to configuring data for supporting Operations, Administration and Management (OAM) signalling in an Ethernet network.

### BACKGROUND TO THE INVENTION

There is significant interest in using Ethernet switches in carrier networks. Use of Ethernet switches in carrier networks has the advantages of interoperability (mappings between Ethernet and other frame/packet/cell data structures such as IP, Frame Relay and ATM are well known) and economy (Ethernet switches are relatively inexpensive compared to IP routers, for example).

Two notable technologies which allow the use of Ethernet switches in carrier networks are Provider Backbone Bridges (PBB) and Provider Backbone Bridge Traffic Engineering (PBB-TE). Provider Backbone Bridges (PBB), also known as Mac-in-Mac, is described in the Institute of Electrical and Electronics Engineers (IEEE) standard 802.1ah. PBB is a technology which allows for layering of the Ethernet network into customer and provider domains with complete isolation among their MAC addresses. In this way, a customer's traffic can be carried transparently across a carrier's Ethernet network. Nortel has proposed a form of ‘Connection-oriented Ethernet’ (CoE) which is described in WO 2005/099183 and in the paper “Ethernet as Carrier Transport Infrastructure”, David Allan, Nigel Bragg, Alan McGuire, Andy Reid, IEEE Communications Magazine February 2006. PBB-TE is being standardised by the IEEE as IEEE 802.1Qay under the descriptor Provider Backbone Bridge Traffic Engineering (PBB-TE). In a PBB-TE network, the conventional Ethernet processes of ‘flooding’ and ‘learning’ are disabled and, instead, managed traffic paths are set up across the network of Ethernet switches. A network manager in the control plane instructs each Ethernet switch along a path to store forwarding instructions. The switch uses the forwarding instructions to forward received data frames. The forwarding instructions operate on a particular combination of identifiers in a data frame, such as a Virtual Local Area Network Identifier (VLAN ID or VID) and the destination MAC address (DA). As traffic is now constrained to follow pre-determined paths through the network, this allows network operators to perform traffic engineering on the Ethernet network, such as planning working and protection paths having diverse routes through the network and provisioning additional trunks to increase capacity.

It is proposed that Ethernet-based carrier networks will have a similar range of Operations, Administration and Management (OAM) capabilities as other carrier technologies. OAM for Ethernet networks is being standardised by the IEEE as IEEE 802.1ag and by the ITU as Recommendation ITU-T Y.1731. Currently, IEEE 802.1ag and Y.1731 require per-connection state to be set up specifically for the OAM signalling. This can require individual entries, per node, at various network layers of the network, such as for each link, trunk and service passing through the node. One disadvantage of manually configuring this data, per node, is that it may consume considerable operator time, and further there is considerable scope for an error to be made when assigning an identifier for OAM signalling related to a particular link/trunk/service. A farther disadvantage is that processing the large quantity of data may cause a node to take an excessively long time at boot up, thereby delaying bringing the node into service. A further disadvantage is that the node may have a limit on the maximum size of the configuration file, and the quantity of data may exceed the size of the configuration file. Currently, OAM data is manually configured, on a per-connection basis, at the management level and then sent to each individual node.

IEEE 802.1ag draft 8.1 (Jun. 18, 2007) describes various default values for OAM data. In particular: a default name for a Maintenance Domain is set to the character string “DEFAULT”; a short Maintenance Association (MA) Name of a MA is set to the primary VID, or 0, if the MA is not attached to a VID. These are default values which a Network Management Entity would use, when selecting values for OAM configuration data that will be distributed to nodes.

The present invention seeks to provide an alternative way of configuring OAM data.

### SUMMARY OF THE INVENTION

One aspect of the present invention provides a method of configuring OAM data at a node of an Ethernet network to support an OAM signalling session associated with a connection for carrying data traffic, the method comprising:

the node automatically configuring OAM data required at the node to support the OAM signalling session, by deriving the OAM data from data already associated with endpoints of the connection.

This is particularly advantageous for configuring an identifier for an OAM signalling session, such as an IEEE 802.1ag Maintenance Association Identifier (MAID) or an ITU Y.1731 Maintenance Entity Group Identifier (MEG ID).

This embodiment of the invention can avoid the need to configure any per-connection OAM data at each node of the network. Advantageously, the identifier is derived from another identifier which is (uniquely) associated with all endpoints of the connection that the OAM session is co-routed with, such as identifiers of a trunk or a service. This process can be performed autonomously by each node, without requiring coordination between nodes, although it is also possible for nodes to exchange messaging with other nodes to enable the node to confirm whether an automatically configured value should be used, or modified.

A further aspect of the invention provides a method of configuring OAM data at a node of an Ethernet network to support an OAM signalling session associated with a connection for carrying data traffic, wherein the node is a first endpoint of an OAM signalling session, there also being a second endpoint of the OAM signalling session, the method comprising:

automatically selecting a first identifier for the first endpoint.

This is particularly advantageous for configuring an IEEE 802.1ag Maintenance Association End Point Identifier (MEP ID) or an ITU Y.1731 MEG End Point Identifier (MEG ID), which is conventionally required to be different at each node participating in the MA/MEG. The first identifier can be autonomously derived by the node, independently of other endpoints, and other signalling content, such as source MAC address, is used to differentiate OAM signalling messages rather than relying upon the distinct MEP ID/MEG ID values. Alternatively, a node can automatically configure the first identifier on the basis of information stored locally at the node and signalling with the second endpoint. An arbitration process between endpoint nodes allows each endpoint node to select a distinct value for the first identifier.

A further aspect of the invention provides a method of configuring OAM data at a node of an Ethernet network to support an OAM signalling session associated with a connection for carrying data traffic, the method comprising:

using a global default value for an OAM maintenance domain (MD) to be applied to each type of connection;

automatically configuring an OAM maintenance domain (MD) with the default value.

Advantageously, the global default value is different for each type of connection. The types of connection can include: link; trunk; PBB B-VID; service, pseudo-wire and any other appropriate types of connection.

Advantageously, the global default value for each type of connection further comprises a default value for the OAM maintenance domain (MD) level. Preferably, the default values are locally stored at each node, such as by hard-coding or in response to receiving data from a network management entity, and automatically used whenever a new OAM maintenance domain (MD) is created. This avoids the need for a network management entity to individually configure OAM MD data.

Each of the aspects of the invention has an advantage of reducing, or avoiding, the mis-configuration errors that arise from manually configuring OAM data, per connection/node. A further advantage is that, because OAM data is now automatically configured by the node itself, the configuration file can be much smaller. This, in turn, can reduce boot up time when a node is brought into service. The savings are particularly advantageous where per-service OAM data is required. Deriving OAM data algorithmically has an advantage that there is no need to stored derived information.

A further advantage is that it is now operationally possible to configure OAM on a wider range of connections than previously possible. As an example, conventionally a carrier/service provider may defer configuring OAM at the service level until there is an actual need to perform OAM, such as a customer requesting tests. Conventionally, this would require a network management entity to configure OAM on that particular service at the time of the customer request. This causes delays, and there is also a significant risk that the OAM will be mis-configured. In contrast, the present invention allows a node to automatically configure some, or all, of the OAM data at a node in preparation for performing OAM signalling, without the usual disadvantages of increasing the size of the configuration file and delaying boot up. When there is a need to perform OAM at the service level, the required OAM data (MEP ID, MAID) to support the OAM signalling between nodes has already been configured. This advantage applies to any level of the network, other than just the service level, where the carrier/service provider may conventionally defer configuring OAM data.

The functionality described here can be implemented in software, hardware or a combination of these. The invention can be implemented by means of a suitably programmed computer or any other form of processing apparatus. Accordingly, the invention also provides a network node of an Ethernet network comprising a processor which is configured to perform any of the methods. Another aspect of the invention provides software for implementing any of the described methods. The software may be tangibly embodied on an electronic memory device, hard disk, optical disk or any other machine-readable storage medium. The software may be delivered as a computer program product on a machine-readable carrier or it may be downloaded to a node via a network connection.

### BRIEF DESCRIPTION OF THE DRAWINGS

Embodiments of the invention will be described, by way of example only, with reference to the accompanying drawings in which:

FIG. 1 shows an Ethernet network in which the present invention can be applied;

FIG. 2 shows OAM identifiers for OAM sessions at different levels of the network of FIG. 1;

FIG. 3 shows functional modules at a node of the network of FIG. 2.

### DESCRIPTION OF PREFERRED EMBODIMENTS

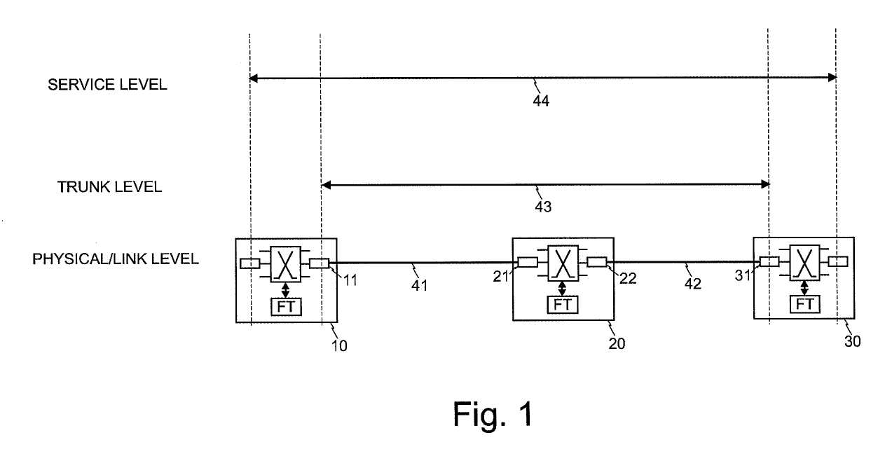

FIG. 1 schematically shows a set of nodes 10, 20, 30 of an Ethernet network. In a known manner, pairs of nodes are physically connected together and a forwarding table (FT) at each node determines the forwarding behaviour of each node. In the case of a PBB network the forwarding table is populated by each node performing a spanning tree algorithm and in a PBB-TE network the forwarding table is populated by a set of instructions received via a control plane. In a carrier network, there are three main levels of connection. At the lowest level, there are the links between nodes. One such forwarding link is shown between port 11 of node 10, and port 21 of node 20; another link is shown between port 22 of node 20, and port 31 of node 30. A trunk can be formed between a pair of endpoints. An example trunk is shown between nodes 10, 30. A trunk follows a route which comprises individual links; in this simple example the route comprises the link between nodes 10 and 20, and between nodes 20 and 30. A trunk can carry one, or multiple, services. An example service is shown between nodes 10, 30. Strictly, the services terminate on the exterior ports of the edge nodes 10, 30, as shown in FIG. 1. In the context of a carrier network, a carrier may define a trunk between particular endpoints (e.g. locations) of the carrier network and then define a service per customer who has a need to carry traffic between those endpoints (locations).

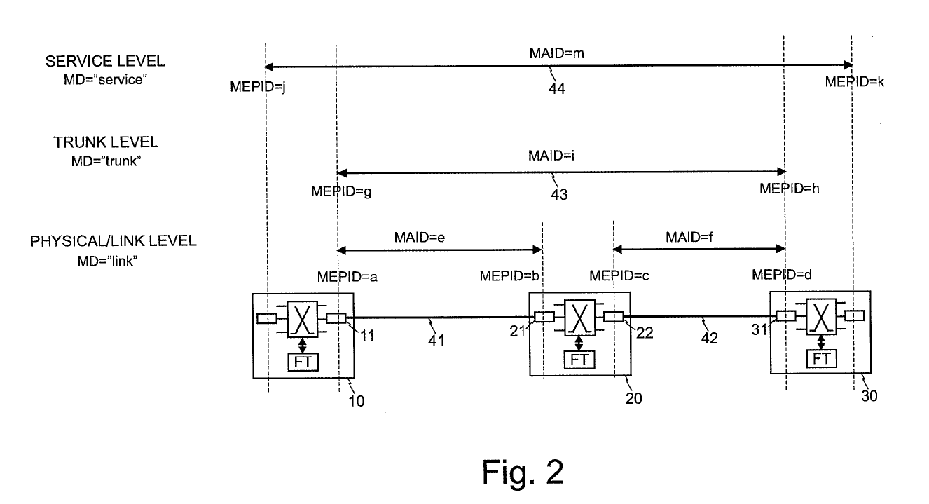

OAM signalling can be performed at any one, or combination of, the link, trunk and service layers/levels of the network. An example of OAM signalling is Connectivity Check (CC) messaging at regular intervals, to ensure that a fault has not occurred on the connection. Other OAM signalling is described in detail in IEEE 802.1ag and ITU-T Y.1731, and includes a range of performance monitoring functions for monitoring, such as: frame loss ratio; frame delay; frame delay variation; throughput. Each node 10, 20, 30 must be configured with OAM entries to support the OAM signalling. IEEE 802.1ag defines the following terms:
Maintenance Domain: The network or the part of the network for which faults in connectivity can be managed.
Maintenance Domain Name: The identifier of a particular Maintenance Domain (which should be unique over the domain for which CFM is to protect against accidental concatenation of service instances).
Maintenance Association (MA): A set of Maintenance Association End Points (MEPs), each configured with the same Maintenance Association Identifier (MAID) and MD Level, established to verify the integrity of a single service instance.
Maintenance Association Identifier (MAID): An identifier for a Maintenance Association, unique over the domain that CFM is to protect against the accidental concatenation of service instances. The MAID has two parts: the Maintenance Domain Name and the Short MA Name.
Maintenance association End Point (MEP): An actively managed CFM entity, associated with a specific DoSAP of a service instance, which can generate and receive CFM PDUs and track any responses. It is an end point of a single MA, and is an endpoint of a separate Maintenance Entity for each of the other MEPs in the same MA.
Maintenance association End Point Identifier (MEPID): A small integer, unique over a given MA, identifying a specific MEP.
   To perform OAM signalling at each of the link, trunk and service layers of FIG. 1: each link 41, 42 requires a set of identifiers (Maintenance Domain Name, MAID, MEPID); each trunk 43 requires a set of identifiers (Maintenance Domain Name, MAID, MEPID) and each service 44 requires a set of identifiers (Maintenance Domain Name, MAID, MEPID). This set of identifiers are shown in FIG. 2. The values of the identifiers shown in FIG. 2, e.g. MEPID=a, are purely illustrative. FIG. 2 shows the simple case of point-to-point trunks and services, although the ideas can also be applied to any-to-any trunks and services.

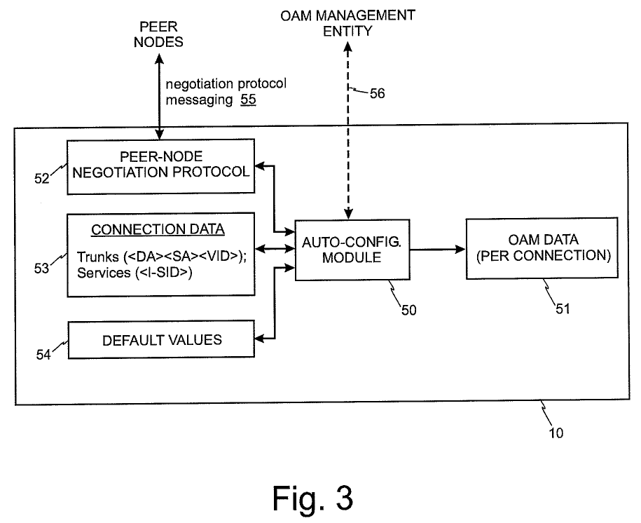

FIG. 3 schematically shows functional modules which can be provided at a node 10, 20, 30 of the network of FIG. 2 to automatically configure OAM data. An auto-configuration module 50 is responsible for populating a table 51 of OAM data at the node. Table 51 stores OAM data, such as a MD name for type of connection, and a set of MAIDs and MEPIDs for the connections. Auto-configuration module 50 uses inputs from one or more of the modules 52-54 to gather data for use in populating table 51. Module 54 store default values for certain OAM data items, such as the MD described below. Connection data 53, maintains information about connections that pass through the node. This can include information about trunks and services, which will each be defines by identifiers such as MAC addresses, VLAN Identifiers (VID), Service Identifiers (I-SID). The information held by module 53 is information which the node must already have to support packet forwarding of data traffic; it is not information that is held especially for OAM purposes. Auto-config. module 50 can automatically (and autonomously) derive OAM data from data 53. The derived data can be stored in table 51. In an alternative embodiment, the node may not actually store the derived data. Instead, module 50 can simply store rules which define, Module 52 allows the node 10 to communicate 55 with other nodes 20, 30. This allows the auto-config. module 50 to select identifier values which are the same (or different) to identifier values selected by similar auto-config. modules at other nodes. Finally, module 50 can communicate 56 with an OAM management entity. Conventionally, table 51 would be populated with per-connection OAM data by the OAM management entity but it will be seen that in accordance with embodiments of the present invention, the OAM data is derived locally by the auto-config. module 50.

### Maintenance Domain (MD)

In accordance with an embodiment of the present invention, a global item of configuration can be set on a node indicating:

the MD to be used for a given “type” of MEP;

the MD level to be used for a given “type” of MEP;

where examples of “type” are: Link; PBB-TE trunk; PBB B-VID; I-SID, where I-SID represents a service at client level. Because the item of configuration data is global, it does not need to be set on a per-connection, or per node, basis.

An example complete set of MDs, minimal for PBB-TE only would be: “Link”; “Trunks”; “ClientISIDs”. Another MD is “BVIDs”, for PBB services, instead of trunks.

IEEE 802.1ag/ITU-T Y-1731 also defines the concept of “levels”, which define hierarchical levels of network entities, in a similar manner to network “layers”. The level is identified within a field carried in an OAM message. The numbering of OAM “levels” does not need to correspond to the numbering of network layers, although the same relative numbering should be followed. An example set of levels for these MDs is: Link=0; Trunks=2; ClientISIDs=0. [Note that 0 has not been re-used—Link & ClientISIDs are in a different number-space as one is within, and the other outside of, the encapsulation.]

### Maintenance Association End Point Identifiers (MEPIDs)

As shown in FIG. 2, a Maintenance Association (MA) exists between two (or more) Maintenance association Endpoints (MEPs). There is currently a requirement in IEEE 802.1ag that the two or more MEPIDs within an MA must be distinct. Considering a Maintenance Association at the trunk level between nodes 10 and 30, i.e. trunk 43, the MEPID used at node 10 must differ from the MEPID used at node 30. In one embodiment of the present invention, a node independently selects a MEPID for the MEP located at the node and the requirement for distinct MEPIDs is circumvented by:
1) Indicating that the MEPID is of a different type, i.e. a node local MEPID. The indication can be achieved by, for example, using one of the reserved bits in the 16-bit MEPID field to indicate that the MEPID has been selected in this manner. The node local MEPID is required to be unique only within the node it sits on.
2) Each node already has a unique MAC address which can be used to identify the source of a Connectivity Fault Message. A node can inspect the source MAC address on the CFM messages and use this as a way of keeping track of which MEPs it is receiving messages from.

In a further embodiment, a node independently selects a MEPID for an entity (e.g. a link) by inheriting a value which has already been configured for another co-routed entity (e.g. a trunk).

In a further embodiment, a node independently selects a MEPID for the MEP located at the node and then enters into a process of discovering what MEPIDs other nodes have allocated to their MEPs and negotiates with the other nodes to ensure that each MEP has a different MEPID. One basis for deciding which node should use a particular MEPID is the unique MAC address of the nodes. As an example, if it is found that two nodes have allocated the same MEPID to their respective MEPs, then the node with the numerically lower MAC address would ‘give in’ to the node with the numerically higher MAC address. The MAC address is an example criterion for reaching a decision on which node to select, but it will be appreciated that another criterion, or combination of criteria, could be used.

### Maintenance Association Identifiers (MAIDs)

There is currently a requirement in IEEE 802.1ag that the Maintenance Association Identifier (MAID) for all of the MEPs on a connection must be configured to be identical. Several options for allowing a node to automatically create the MAID will now be described:

### Algorithmic Derivation

It is possible for a node to derive, by itself, the MAID that should be used for a particular Maintenance Association (MA). A common convention can be followed by each node, which will allow each node to allocate the same MAID to a particular MA. As an example, consider the service 44 between nodes 10 and 30 of FIG. 2. The Service has already been allocated a Service Identifier (I-SID) of value 403. Each node 10, 30 derives a MAID string “I-SID 403” to identify the MA between MEPs. The prefix “I-SID” is not strictly necessary, since the MD already provides the context of ‘ISID’), and it is possible to just use a 3-byte integer. However, the inclusion of the prefix is more user-friendly in real operation.

Each node uses a set of standard mappings, such that distinct nodes associated with a particular service or trunk will autonomously arrive at the same MAID, i.e. there is no coordination between nodes. In the example just given, the rule can be of the form:

inspect the I-SID of the service;

construct a MAID string of the form “I-SID” <space><I-SID integer value>. It will be appreciated that other naming conventions can be used, as long as all nodes are aware of the naming convention and that the naming convention guarantees that the MEPs at each end of a MA will arrive at the same MAID by following the naming convention.

As a further example, the PBB-TE trunk 43 between endpoint nodes 10, 30 is defined by a source MAC address, a destination MAC address, a VLAN identifier (VID), and may also include a user-defined text string for the trunk name. The naming convention at each node can use this triple (Source MAC address, Destination MAC address, VID) as the MAID for the MA associated with the trunk. Another possibility is to use the four tuple of (source MAC address, destination MAC address, forward VID, reverse VID). If source and destination MAC addresses are used as part of the naming convention, then the convention will need to agree on a trunk direction to avoid any ambiguity over which node is the source and which node is the destination. One way of resolving would be to always consider the source of the trunk as the node having the numerically highest MAC address. Similarly, if the naming convention is to use the trunk name (a text string label for the trunk used locally at each endpoint of the trunk) then it would be necessary to ensure that the trunk has the same text string label at each end.

Some further examples of where MAIDs can be automatically allocated are:
when Nortel's proprietary OEL2 encapsulation (functionally equivalent to 802.1ah Mac-in-Mac) is used, derive a MAID from the TDI (functionally equivalent to 802.1ah's I-SID) as e.g. “TDI-1043”;
when pseudo-wire encapsulation is used, derive a MAID from the pseudo-wire connection ID;
For a MultiProtocol Label Switching (MPLS) Label Switched Path (LSP), derive a MAID from the connection identifier passed around in the RSVP-TE signalling, or similar signalling e.g. Label Distribution Protocol (LDP) signalling;
For anything (photonic connections, SDH pipes etc.) set up with Generalized MultiProtocol Label Switching (GMPLS) derive a MAID from the GMPLS connection ID passed in the RSVP-TE or Constraint-based Routing Label Distribution Protocol (CR-LDP) signalling.
For any kind of service, derive a MAID using the subscriber ID or internal circuit ID.

### Auto-Discovery

This approach is less desirable that the algorithmic derivation, and is useful where it is not possible to derive the MAID algorithmically. Firstly, a new MAID type is allocated (out of the reserved range) indicating that this method of deriving MAID strings is being used. Each endpoint node uses a locally-allocated MAID string. The MAID string could be derived algorithmically, as described above, or by a different method.

### Option A

Maintain equal MAIDs [Relies on a steady message flow—e.g. of CCs.] The node with the numerically lower MAC address would ‘give in’ to the node at the other end, and start to use the MAID that had been allocated by the numerically higher MAC address. The MAC address is an example criterion for reaching a decision on which node to select, and another criterion, or criteria, could be used. In a situation where a third MEP is added to the connection, it is possible to either:
re-perform the method described above. The MAID allocated by the node having the numerically highest MAC address is used by the MEPs at the set of nodes. This method can be extended to higher numbers of nodes. This option is possible if the software supports a change of MAID.
use a two-stage discover/advertise protocol that resolves any conflicts between the nodes initially present by, e.g. source MAC address of nodes, and then locks in the MAID to use. This option differs in that the first two nodes can be in ‘advertise’ rather than ‘discover’ mode such that the third new node, starting off in discover mode, realises that it should just listen to what it's told rather than trying to negotiate (regardless of whether it has the highest MAC address).

### Option B

Live with different MAIDs. This option is less desirable as it does not guarantee that the MAID derived by MEPs at both ends of a MA will be the same and therefore breaches the requirement of IEEE 802.1ag. A MEP would respond to any MAID that talked to it. There is a minor security issue here of unauthorised MEPs communicating with an authorised MEP, but there is little the unauthorised MEP can do that would cause harm and, in any event, in normal usage it is possible to spoof a valid MAID. Logging contact with a new MAID should resolve this concern.

In all of the above described options, it is possible to override the defaults for automatically creating MD names, and for auto-creating values of MEPIDs and MAIDs.

The above description uses the terminology defined in IEEE 802.1ag. ITU-T Y.1731 uses similar terminology to define similar concepts as IEEE 802.1ag. Notable differences are that ITU-T Y.1731 uses the terms: Maintenance Entity Group (MEG) rather than Maintenance Association (MA); the term Maintenance Entity Group Identifier (MEG ID) rather than Maintenance Association Identifier (MAID); MEG End Point (MEP) rather than Maintenance Association End Point (MEP); and MEG End Point Identifier (MEP ID) rather than Maintenance Association End Point Identifier (MEP ID).

The invention is not limited to the embodiments described herein, which may be modified or varied without departing from the scope of the invention.

We claim:

1. A method of configuring OAM data at a node of an Ethernet network to support an OAM signalling session associated with a connection for carrying data traffic, the method comprising:
the node automatically configuring OAM data required at the node to support the OAM signalling session, by deriving the OAM data from data already associated with endpoints of the connection.

2. A method according to claim 1 wherein the step of automatically configuring OAM data at the node automatically derives an identifier for an OAM signalling session using a naming convention, the naming convention being common to all nodes which participate in the OAM signalling session.

3. A method according to claim 1 wherein the connection is a service between endpoint nodes and the OAM data is an identifier for an OAM signalling session for the service.

4. A method according to claim 3 wherein the service is defined by a Service Identifier (I-SID), and at least part of the Service Identifier is used to configure the identifier for the OAM signalling session associated with the service.

5. A method according to claim 1 wherein the connection is a trunk between endpoint nodes and the OAM data is an identifier for an OAM signalling session for the trunk.

6. A method according to claim 5 wherein the trunk is a PBB-TE trunk which is defined by at least one of:
the triple of: a source MAC address; a destination MAC address; a VLAN identifier (VID);
the four tuple of: a source MAC address; a destination MAC address; a forward VLAN identifier (VID); a reverse VLAN identifier (VID);
a trunk name;
and the method uses at least one of these items to configure the identifier for the OAM signalling session associated with the trunk.

7. A method according to claim 1 wherein the node autonomously derives the identifier for the OAM signalling session.

8. A method according to claim 1 wherein the node automatically configures a first identifier for an OAM signalling session and the method further comprises:
receiving a second identifier for the OAM signalling session that has been derived by a second node participating in the OAM signalling session; and
if the second identifier has a different value to the first identifier, selecting one of the identifiers for use as the identifier of the OAM signalling session.

9. A method according to claim 8 wherein each of the nodes participating in the OAM signalling session has a MAC address, and one of the first and second identifiers is selected based on the respective MAC addresses of the nodes.

10. A method according to claim 1 where the OAM data is an identifier for the OAM signalling session and is a Maintenance Association Identifier (MAID) or a Maintenance Entity Group Identifier (MEG ID).

11. A computer program product comprising a machine-readable medium bearing instructions which, when executed by a processor, cause the processor to implement the method of claim 1.

12. A network node of an Ethernet network comprising a processor which is configured to perform the method of claim 1.

13. A method of configuring OAM data at a node of an Ethernet network to support an OAM signalling session associated with a connection for carrying data traffic, wherein the node is a first endpoint of an OAM signalling session, there also being a second endpoint of the OAM signalling session, the method comprising:
automatically selecting a first identifier for the first endpoint.

14. A method according to claim 13 wherein the step of automatically selecting comprises selecting the first identifier independently of the second endpoint.

15. A method according to claim 14, wherein the node indicates that the identifier of the first endpoint has been locally selected by modifying a part of the identifier when signalling to other nodes.

16. A method according to claim 14 wherein the node determines when an OAM signalling message has been sent by the second endpoint by inspecting a source address in an OAM signalling message.

17. A method according to claim 13 wherein the step of automatically configuring comprises selecting the first identifier on the basis of information stored locally at the node and signalling with the second endpoint.

18. A method according to claim 17 further comprising:
receiving a second identifier which the second endpoint has locally selected as an identifier for the second endpoint of the OAM signalling session; and
if the first identifier has the same value as the second identifier, determining if the node needs to modify the value of the first identifier.

19. A method according to claim 18 wherein each of the nodes participating in the OAM signalling session has a MAC address, and the respective MAC addresses of the nodes are used to determine if the node needs to modify the value of the first identifier.

20. A method according to claim 13 where the identifier for the endpoint of the OAM signalling session is a Maintenance association End Point Identifier (MEPID) or a MEG End Point Identifier (MEP ID).

21. A computer program product comprising a machine-readable medium bearing instructions which, when executed by a processor, cause the processor to implement the method of claim 13.

22. A network node of an Ethernet network comprising a processor which is configured to perform the method of claim 13.

23. A method of configuring OAM data at a node of an Ethernet network to support an OAM signalling session associated with a connection for carrying data traffic, the method comprising:
using a global default value for an OAM maintenance domain (MD) to be applied to each type of connection;
automatically configuring an OAM maintenance domain (MD) with the default value.

24. A method according to claim 23 wherein the global default value is different for each type of connection.

25. A method according to claim 24 wherein the types of connection are: link; trunk; PBB B-VID; service, pseudo-wire.

26. A method according to claim 23 wherein the global default value for each type of connection farther comprises a default value for the OAM maintenance domain (MD) level.

27. A computer program product comprising a machine-readable medium bearing instructions which, when executed by a processor, cause the processor to implement the method of claim 23.

28. A network node of an Ethernet network comprising a processor which is configured to perform the method of claim 23.
